(19) United States
(12) Patent Application Publication
(10) Pub. No.: US 2010/0055258 A1
(43) Pub. Date: Mar. 4, 2010

(54) Bread Product

(76) Inventor: Sandra K. Bernard, Fulton, MO (US)

Correspondence Address: SPENCER, FANE, BRITT & BROWNE, 1000 WALNUT STREET, SUITE 1400, KANSAS CITY, MO, 64106-2140, US

(21) Appl. No.: 12/200,780

(22) Filed: Aug. 28, 2008

(51) Int. Cl. A21D 13/00

(52) U.S. Cl. 426/138

(57) ABSTRACT

A bread product having a length greater than a width thereof and a longitudinal slice along a length thereof. The slice defines two halves of the bread product. The bread product includes a groove extending along at least a portion of a longitudinal length of at least one of the halves, and is for receiving a food product therein.

### RELATED APPLICATIONS

Not applicable.

### BACKGROUND OF THE INVENTION

1. Field of the Invention

The present invention is directed to baked bread products, specifically soft rolls or buns. More specifically, the present invention is directed to improved hot dog or frankfurter buns.

2. Description of the Prior Art

Soft-crusted hot dog or frankfurter buns are well known in the art. These are typically available, prepackaged, for retail purchase by the consumer. The buns are oblong in shape and are generally sold with a slice extending longitudinally along the bun such that the bun is easily opened to receive a hot dog and condiments between the two halves.

The longitudinal slice in a conventional hot dog bun provides smooth opposing surfaces inside the bun when the bun is opened. When a hot dog and condiments are placed in the bun, the bun has a tendency to break apart, particularly when over-filled, so that the two halves separate, thereby making the hot dog more difficult to eat. Even when the bun remains in one piece, the condiments added to the hot dog often exceed the confines of the bun, or fall out of the bun altogether when the hot dog is being eaten. What is needed, therefore, is a bun adapted to receive a hot dog or other food item, as well as condiments, in defined areas of the bun, such that the bun resists breaking apart and over-filling.

### SUMMARY OF THE INVENTION

The present invention provides bread product having a length greater than a width thereof and a longitudinal slice along a length thereof. The slice defines two halves of the bread product. The bread product includes a groove extending along at least a portion of a longitudinal length of at least one of the halves, and is for receiving a food product therein.

One aspect of the invention provides two grooves, one extending along at least a portion of the longitudinal length of each half, for receiving food products therein.

Another aspect of the present invention provides that the grooves in the bread product define a generally circular cross-section within the bread product when said first and second halves of the bread product are substantially closed.

Another aspect of the present invention provides that the grooves define a generally rectangular cross-section within the bread product when said first and second halves of the bread product are substantially closed.

Another aspect of the present invention provides that the grooves define a generally diamond-shaped cross-section within the bread product when the first and second halves of the bread product are substantially closed.

Another aspect of the present invention provides that the grooves define a generally L-shaped cross-section within the bread product when the first and second halves of the bread product are substantially closed.

Yet another aspect of the present invention provides that the grooves extends along an entire longitudinal length of the bread product.

Another aspect of the present invention provides that at least one of the grooves is sized and shaped to receive a hot dog therein.

Still another aspect of the present invention provides that at least one of the grooves is sized and shaped to receive a bratwurst therein.

### BRIEF DESCRIPTION OF THE DRAWING FIGURES

FIG. 1 is a top view of an open bun of the present invention.

FIG. 2 is a top view of one half of a bun of the present invention.

FIG. 3 is a cross-sectional view of a bun of the present invention, the bun having a meat product included therein.

FIG. 4 is a top view of an open bun product of the present invention, one half of the bun having a meat product included therein, the other half of the bun having a condiment included therein.

FIG. 5 is a cross-sectional view of a bun of the present invention, the bun having a groove in only one half of the bun.

FIG. 6 is a cross-sectional view of a bun of the present invention, the bun having groove in both halves of the bun.

FIG. 7 is a cross-sectional view of a bun of the present invention, the bun having groove in both halves of the bun.

### DETAILED DESCRIPTION OF THE INVENTION

Definitions:

As used herein, the term “food product” refers to any edible food, including but not limited to meats, vegetables, fruits, candies, condiments, seasonings, and the like.

Turning to the drawings, wherein like numerals refer to like parts, the numeral 10 refers generally to a hot dog bun constructed in accordance with the principles of the present invention. Bun 10 includes bread 12, first groove 14, and second groove 16.

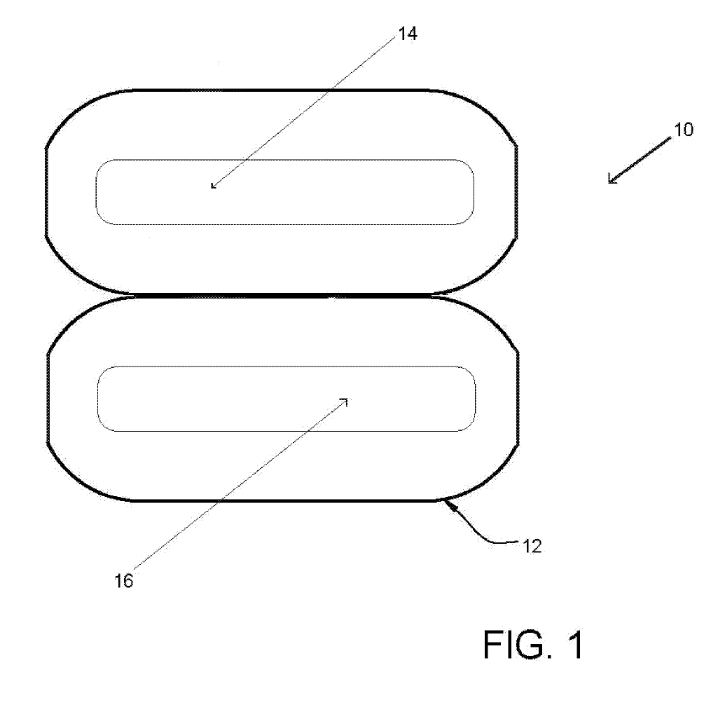

As shown in FIG. 1, bread 12 is open, with the interior of two halves of bread 12 exposed and shown in the figure. First groove 14 runs longitudinally along a length of an interior of a first half of bread 12, whereas second groove 16 runs longitudinally along a length of an interior of a second half of bread 12. Grooves 14 and 16 may be of any suitable length, width, or depth, and these may vary depending upon the uses for which bun 10 is intended. For example, while FIG. 1 is directed to an exemplary bun 10 of the present invention adapted for use with a hot dog, other buns may be constructed in accordance with the present invention for use with bratwurst, sausages, or other food products.

Use of bun 10 is straightforward. It is contemplated that, in a retail setting, buns 10 will be provided with a longitudinal slice similar to that provided with conventional hot dog buns. When a consumer wishes to use a bun 10 for a hot dog, the consumer opens bun 10 along the longitudinal slice, exposing grooves 14 and 16 contained therein. The consumer then places the hot dog in one of grooves 14 or 16, and places desired condiments such as ketchup, mustard, relish, cheese, onions, chili, and the like in the other of grooves 14 or 16. Meat products, condiments, or any other foods included in bun 10 may be referred to generally as food products. Bun 10 can then be closed once again, with the hot dog and condiments remaining securely enclosed within their respective grooves 14 or 16. The finished food product, including bun 10, a hot dog, and desired condiments, can be consumed easily and without mess, as the various components of the food product are held firmly within bun 10.

With respect to bun 10, grooves 14 and 16 may be of substantially the same size and shape. Thus, in bun 10 as shown in FIG. 1, a hot dog may be placed in either groove 14 or 16, and condiments may be placed in the other groove 14 or 16. It is contemplated, however, that grooves 14 and 16 may be provided such that each of the grooves has a different size or shape. Variations of the size and shape of grooves 14 and 16 are considered well within the scope of the present invention. Exemplary variations in the grooves of the present invention are described in more detail below.

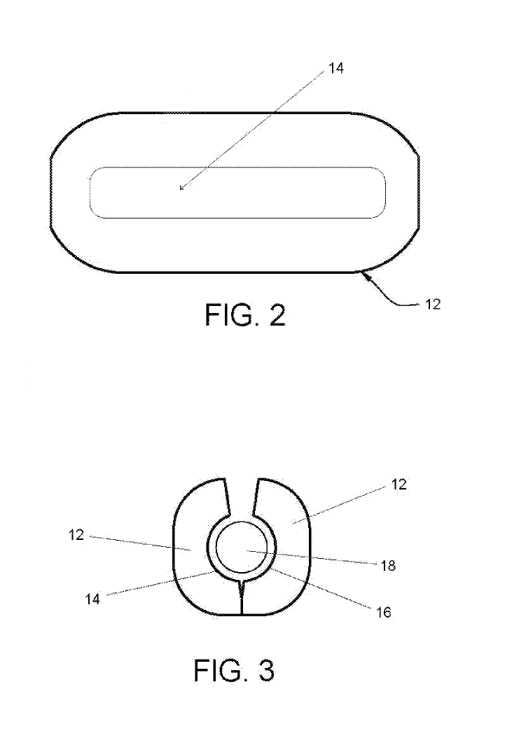

FIG. 2 provides an illustration of a top view of a single half of bun 10 of the present invention, and depicts one half of bread 12 with groove 14 shown therein. Groove 14 may be adapted to receive a hot dog or other food product, or a variety of condiments. For purposes of the present invention, which groove, either 14 or 16, receives a food product, and which receives condiments is immaterial. When grooves 14 and 16 are of substantially the same size and shape, it is contemplated that either may just as readily receive a hot dog or other food product. When grooves 14 and 16 are of substantially different sizes or shapes, the size and shape of the food product, such as a hot dog, used with the bun may dictate which groove is best able to receive the food product. Either of grooves 14 and 16 may receive a food product, or both may receive food products. Similarly, one may receive a food product and another left empty. The novel structure of bun 10 is the important feature of the present invention, and bun 10 is not limited by a particular use thereof.

FIG. 3 provides a cross-sectional view of bun 10 of FIG. 1, the cross-sectional view showing a hot dog 18 situated within bread 12. Grooves 14 and 16 conform roughly to the shape of the hot dog. Although condiments are not shown in FIG. 3, it is contemplated that condiments present in bun 10 of FIG. 3 would take up the space surrounding hot dog 18, either to the left or right thereof as shown in the figure, depending on whether the condiments were contained within groove 14 or groove 16.

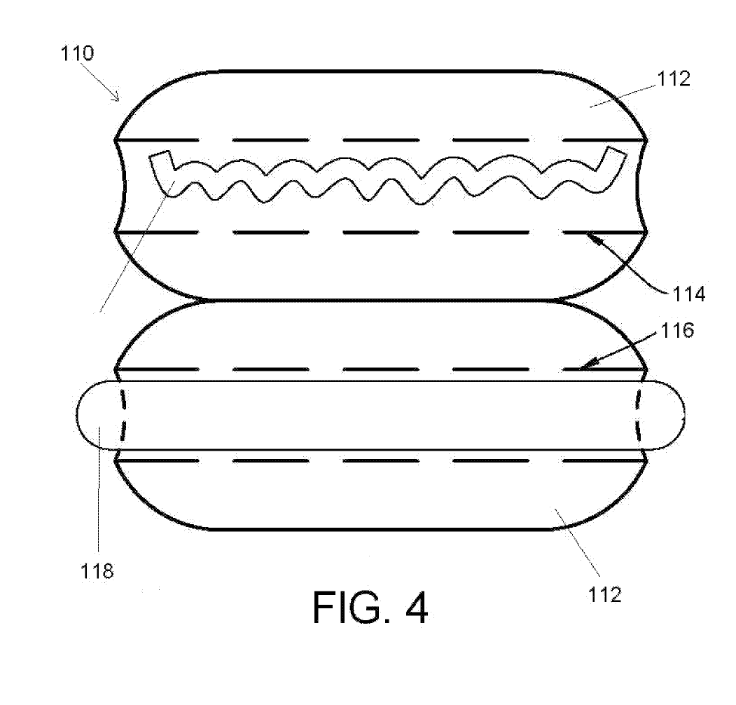

Another aspect of the present invention provides bun 110, shown in FIG. 4. Bun 110 is shown in a top view, with the bun opened to expose the interior thereof. It is again contemplated that bun 110 would be provided to a consumer with a slice cut in the bun, as typically found in hot dog buns sold at retail, for ease of opening by the consumer. Bun 110 includes bread 112, which opens into two halves. A first half of bread 112 includes a longitudinal groove 114 that runs the entire length of bread 112. Likewise, a second half of bread 112 includes a longitudinal groove 116 that runs the entire length of bread 112. Also shown in FIG. 4 are hot dog 118 and condiments 120. Hot dog 118 is situated in groove 116 such that a portion of hot dog 18 extends beyond the edge of bread 112 on both sides. Condiment 120, which may be any suitable condiment such as, for example, ketchup or mustard, is shown occupying groove 114. It is contemplated that any food product or condiment may occupy either groove 114 or groove 116, and that it is not necessary that any food product extend beyond the edge of bread 112. As with bun 10, the novel structure of bun 110, having grooves extending across the entire length thereof, form the important aspect of the invention. Bun 110 is not limited to any particular use.

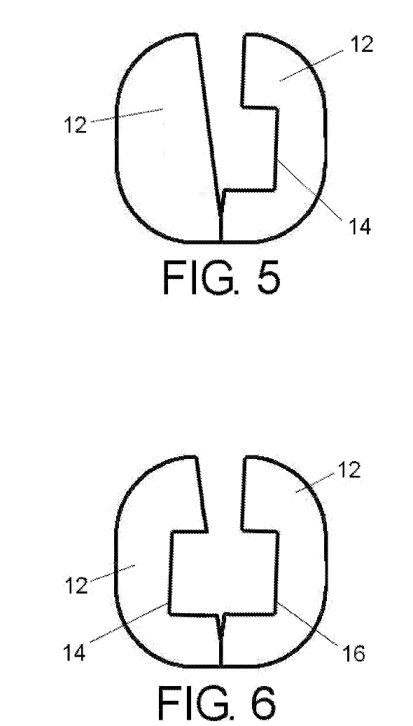

FIG. 5 provides one alternative configuration of groove for use in a bun of the present invention. In the bun shown in FIG. 5, bread 12 is separated into two halves, as with the bun configurations described above. In the bun shown in FIG. 5, however, only one half of the bun includes a groove 14. As shown in the figure, groove 14 is in the right half of bread 12 from the perspective of one viewing the figure, and groove 14 has the general shape of half a square or rectangle. It is contemplated, however, that the groove may be present on either side of bread 12, and that any suitable size or shape of groove 14 may be utilized.

FIG. 6 provides another alternative configuration of grooves for use in conjunction with a bun of the present invention. As shown in FIG. 6, bread 12 includes two grooves 14 and 16, both of which have the general shape of a polygon. The polygon maybe roughly rectangular, as shown in the figure, square-shaped, or utilize any other suitable shape.

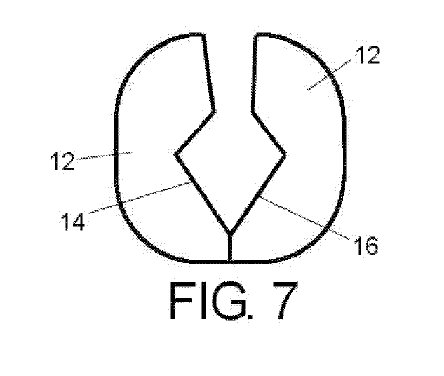

FIG. 7 provides yet another alternative configuration of grooves for use in conjunction with a bun of the present invention. As shown in FIG. 7, the grooves 14 and 16 in bread 12 give a generally diamond shape to the grooves when bread 12 is viewed in cross-section, as in the figure. It is noted again, however, that any suitable size, shape, or configuration of grooves may be used in conjunction with a bun of the present invention.

Further, the number and placement of grooves in a bun of the present invention may vary. For example, multiple longitudinal grooves may be formed in a single half of bread 12 of a bun of the present invention. Two grooves may be provided, for example, in parallel along a portion of the longitudinal length of a half of bread 12. Grooves 14 and 16 also need not be parallel to a top or bottom of bun 12, but may be provided at an angle. For example, a groove may run from near the top of a front of bun 10 to near the bottom of a rear of bun 10. Multiple variations on the size, placement, angle, or shape of grooves 14 and 16 will be readily apparent to those of skill in the art upon reading this disclosure, and it is contemplated that these are well within the scope of the present invention.

The manufacture of buns, such as hot dog buns, is well known in the art, and varied techniques for such manufacture are known to those of skill in the art. It is contemplated that one of skill in the art will be able to manufacture the novel bun of the present invention without undue experimentation upon reading this disclosure. Methods of manufacture may include mechanical methods of creating the various grooves described above after a bun has been baked, or using a baking process by which the buns are baked with the necessary grooves fully formed during baking. The present invention is not limited to any specific method of making the bun.

The detailed description set forth above is provided to aid those skilled in the art in practicing the present invention. The invention described and claimed herein, however, is not to be limited in scope by the specific embodiments disclosed because these embodiments are intended to be illustrative of several aspects of the invention. Any equivalent embodiments are intended to be within the scope of the present invention. Various modifications of the invention that do not depart from the spirit or scope of the present invention, in addition to those shown and described herein, will become apparent to those skilled in the art from the foregoing description. For example, either of buns 10 or 110 may be provided with a groove only in one side of bread 12 and 112, respectively. The opposing side of bread 12 or 112 may be smooth or flat, generally the same structure as a standard hot dog bun. These and other modifications are also intended to fall within the scope of the appended claims.

1. A bread product having a length greater than a width thereof and a longitudinal slice along a length thereof, the slice defining two halves thereof, the bread product comprising:
a groove extending along at least a portion of a longitudinal length of at least one half of said bread product, for receiving a food product therein.

2. The bread product according to claim 1 wherein said two halves are a first half and a second half, and wherein said groove is a first groove and extends along at least a portion of the longitudinal length of said first half, further comprising:
a second groove extending along at least a portion of a longitudinal length of a second half of said bread product for receiving a food product therein.

3. The bread product according to claim 2 wherein said first groove and said second groove define a generally circular cross-section within said bread product when said first and second halves of said bread product are substantially closed.

4. The bread product according to claim 2 wherein said first groove and said second groove define a generally polygonal cross-section within said bread product when said first and second halves of said bread product are substantially closed.

5. The bread product according to claim 2 wherein said first groove and said second groove define a generally diamond-shaped cross-section within said bread product when said first and second halves of said bread product are substantially closed.

6. The bread product according to claim 2 wherein said first groove and said second groove define a generally L-shaped cross-section within said bread product when said first and second halves of said bread product are substantially closed.

7. The bread product according to claim 1 wherein said groove extends along an entire longitudinal length of said bread product.

8. The bread product according to claim 2 wherein at least one of said first and second grooves extends along an entire longitudinal length of said bread product.

9. The bread product according to claim 1 wherein said groove is sized and shaped to receive a hot dog therein.

10. The bread product according to claim 2 wherein at least one of said first and second grooves is sized and shaped to receive a hot dog therein.

11. The bread product according to claim 1 wherein said groove is sized and shaped to receive a bratwurst therein.

12. The bread product according to claim 2 wherein at least one of said first and second grooves is sized and shaped to receive a bratwurst therein.
